(19) United States
(12) Patent Application Publication
(10) Pub. No.: US 2004/0078819 A1
(43) Pub. Date: Apr. 22, 2004

(54) Apparatus and method for content-recording and contents playback, and recording medium thereof

(76) Inventors: Taiji Sawada, Iizuka (JP); Shiro Iwasaki, Iizuka (JP); Eiichi Hatae, Kaho-Gun (JP); Hiroyuki Yoshida, Kasuya-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/647,233

(22) Filed: Aug. 26, 2003

(30) Foreign Application Priority Data
Aug. 27, 2002 (JP) 2002-246672

(51) Int. Cl. H04N 7/16; H04N 7/173; G06F 13/00; H04N 5/445; G06F 3/00

(52) U.S. Cl. 725/58; 725/134; 725/142

(57) ABSTRACT

The content-recording apparatus comprises the display-control unit generating the signal-for-display device, based on the network connection unit acquiring the contents data via the network, the content-recording unit recording the contents data, and the content data recorded in the content-recording unit. When the content data acquired via the network by the network connection unit is recorded in the content-recording unit and is reproducible, the display-control unit generates the signal for the monitor notifying a user the reproduction of the content data.

### BACKGROUND OF THE INVENTION

1. Field of the Invention

This invention relates to a content-recording apparatus, which can easily reproduce content data acquired via a network or from a broadcasting station, and an art related thereto.

In this specification, “contents” means an arbitrary combination of a dynamic image, a still picture, a text, or a pictograph, and “content data” means digital data that the above-mentioned contents are recorded in arbitrary formats.

2. Description of the Related Art

In recent years, in order to be in communication with a partner, opportunity to send and receive an E-mail is increasing via networks, such as the Internet.

In this E-mail, data, such as not only the alphabetic data equivalent to replacement of a letter but also audio, a still picture, or a dynamic image, can be sent and received as attachments.

However, in exchanging content data, attaching data taken with a video camera requires some knowledge and experiences, and it is not an easy activity for the general user who is not skilled in a computer.

Considering this point, published Japanese Patent Application Laid-Open No. 10-171728 disclosed an art that provides a video camera with a data format for attaching video data to an E-mail. As a result, handling of image data has become easier.

In addition, for the side of transmitting image data, various improvements are similarly made.

A sender of an E-mail, that is a user who takes pictures with a video camera and sends the image data, has some mechanical or electrical background, and is often familiar with computer environment.

However, a receiver of an E-mail, that is a user who receives the image data and looks at this (for example, elderly people or children), does not often have such background.

Even though a user receives an E-mail with attached image data, the data is wasted if the user can not play back the image data.

In order to make the operation easier for the side of the E-mail receiver, an art that allots the E-mail to a TV channel is proposed in published Japanese Patent Application Laid-Open No. 2001-249864.

By doing so, a user, who receives image data, can easily reproduce the data just pushing a button of a TV remote controller.

(Problem 1)

In conventional content-recording apparatus, while a user is reproducing the contents he/she wants to see, nothing happens to the contents being reproduced, even if a content-recording apparatus receives new content data.

For this reason, the user sometimes remains not knowing that new content data was received.

(Problem 2)

Some conventional content-recording apparatuses have a function of an EPG program table, but this EPG program table corresponds to only the data via a broadcasting station.

Therefore, compared with the data via a broadcasting station, there was a problem that the handling of the content data via an E-mail is troublesome and difficult to understand.

### OBJECTS AND SUMMARY OF THE INVENTION

A first object of the present invention is to provide a content-recording apparatus that is able to let users certainly know that new content data is received, and the art related thereto.

A second object of the present invention is to provide a content-recording apparatus that can handle content data via an E-mail more easily, and the art related thereto.

The first aspect of the present invention provides a content-recording apparatus comprising: a network connection unit operable to acquire content data via a network; a TV program-acquiring unit operable to acquire content data from a broadcasting station; a content-recording unit operable to record the content data acquired via the network and the content data acquired from the broadcasting station; an entering unit operable to receive command information entered by a user; a display control unit operable to generate a signal-for-display-device based on the content data recorded onto the content-recording unit; and a control unit operable to search at the content-recording unit content data related to the command information entered by said entering unit to make, when the content data related to the command information received by the entering unit exists, the display control unit generate a signal-for-display-device based on the content data related to the command information entered by said entering unit, wherein, when the content data acquired by the network connection unit via the network has been recorded onto said content-recording unit and has been able to reproduce, the display control unit generates a signal-for-display-device notifying the user that the content data acquired by the network connection unit via the network has been recorded onto the content-recording unit and has been able to reproduce.

According to the construction described above, when new content data is received while the user is reproducing the contents which he/she wants to see, a user is notified that the new content data has received.

Therefore, a user can be certainly aware of the reception of the new content data.

Because content data is recorded in the content-recording unit, not only content data acquired on real time, but also the content data acquired in the past can be viewed and listened.

If a user inputs command information from an entering unit, in a content-recording unit, the content data that command information indicates will be searched, and the display will be performed by the corresponding content data.

Therefore, without a difficult operation, a user can reproduce the content data received from a network, such as the Internet, on a monitor, in a similar manner as for the content data acquired from a broadcasting station. The user also can easily view and listen to the content data, received via a network.

A second aspect of the present invention as defined in the first aspect of the present invention provides a content-recording apparatus, wherein when the content data acquired by the network connection unit via the network has been recorded onto the content-recording unit and has been able to reproduce, the display control unit generates a signal-for-display-device displaying a sub screen notifying the user that the content data acquired by the network connection unit via the network has been able to reproduce.

According to the construction described above, a user can be aware that content data is acquired via the network by looking at the sub screen.

Therefore, without overlooking, a user can certainly view and listen to the content data acquired via the network.

Since a main screen still reproduces contents which a user wants to see, he/she can also continue viewing and listening to these contents as it is.

A third aspect of the present invention as defined in the second aspect of the present invention provides a content-recording apparatus, wherein the display control unit closes the sub screen when the content data notified by the sub screen is reproduced.

According to the construction described above, a sub screen can be prevented from interfering with reproduction of content data a user wants to see.

A fourth aspect of the present invention as defied in the second aspect of the present invention provides a content-recording apparatus, wherein the display control unit changes the sub screen as time goes on.

For example, the sub screen will be made smaller in size when a certain period of time passes.

By this change of size, according to the construction described above, an over looking of the reception of the content data ca be prevented, and a sub screen can be prevented from being an interruption and a user can comfortably view and listen.

On the contrary, when a certain period of time passes, the sub screen will be made larger in size, in order to call the user's attention more.

A fifth aspect of the present invention as defined in the first aspect of the present invention provides a content-recording apparatus, wherein when, while displaying nothing, the content data acquired by the network connection unit via the network has been recorded onto the content-recording unit and has been able to reproduce and displaying based on a signal-for-display-device has begun, the display control unit generates a signal-for-display-device displaying a sub screen notifying the user that the content data acquired by the network connection unit via the network has been able to reproduce.

According to the construction described above, even when the power supply of a monitor is in a state of “OFF” or “standby”, an oversight of the content data reception by a user can be prevented.

In this way, content data can be received in the background to the display of a monitor, and convenience will drastically improve.

For example, a user turns off a monitor while he/she is out. In a case where content data is received via the network during his/her absence, a sub screen will be displayed when he/she comes home and turns the monitor on.

Because a function, which is called an automatic recording, will be demonstrated, a user does not need to worry about reception of content data when he/she wants to go out, and it is very convenient.

A sixth aspect of the present invention as defined in the second aspect of the present invention provides a content-recording apparatus, wherein the sub screen comprises character information.

According to the construction described above, a notice can be correctly performed by characters.

A seventh aspect of the present invention as defied in the second aspect of the present invention provides a content-recording apparatus, wherein a sound is reproduced while displaying the sub screen.

According to the construction described above, by reproducing sound with a display, a user's attention can be called more, and it can be considered as a system gentle to blind people.

An eighth aspect of the present invention as defined in the second aspect of the present invention provides a content-recording apparatus, wherein the sub screen comprises one or more of items selected from a group of a title, a message, transmission source information, transmission time, receiving time, reproduction time length, and data size.

These items can correctly inform a user of the many elements of the received content data.

A ninth aspect of the present invention as defined in the second aspect of the present invention provides a content-recording apparatus, wherein the sub screen comprises a channel number assigned to the content data recorded onto the content-recording unit.

According to the construction described above, a user can easily reproduce the target content data when a channel is inputted from an entering unit.

A tenth aspect of the present invention as defined in the first aspect of the present invention provides a content-recording apparatus, wherein when the content data acquired by the network connection unit via the network has been recorded onto the content-recording unit and has been able to reproduce, the display control unit generates a signal-for-display-device reproducing a sound notifying the user that the content data acquired by the network connection unit via the network has been able to reproduce.

According to the construction described above, without influencing the screen display of a monitor, a user can be notified that content data is capable of reproduction.

A eleventh aspect of the present invention as defined in the second aspect of the present invention provides a content-recording apparatus, wherein the sub screen comprises one or more of items selected from a group of a still image and the content data acquired by the network connection unit via the network.

According to the construction described above, contents of the content data which is possible to reproduce can be notified intelligibly for a user, by displaying still pictures of a representative screen of content data, or displaying the digest version of content data on a sub screen, for example.

A twelfth aspect of the present invention provides a content-recording apparatus comprising: a network connection unit operable to acquire content data via a network; a TV program-acquiring unit operable to acquire content data from a broadcasting station; a content-recording unit operable to record the content data acquired via the network and the content data acquired from the broadcasting station; and a display control unit operable to generate, according to EPG information that the network connection unit and/or the TV program-acquiring unit have/has acquired from the broadcasting station, a signal-for-display-device displaying a content list, wherein the content list manages the content data acquired by the TV program-acquiring unit and the content data acquired by the network connection unit equivalently.

According to the construction described above, a user can use seamlessly and easily by looking at a contents list, without distinguishing intentionally the content data via a broadcasting station and the content data via a network.

A thirteenth aspect of the present invention as defined in the twelfth aspect of the present invention provides a content-recording apparatus wherein the content-recording unit records the content data acquired by the network connection unit relating to a channel assigned to a transmitter and/or a transmitter's group having transmitted the content data acquired by the network connection unit; wherein the content-recording unit records the content data acquired by the TV program-acquiring unit relating to a channel assigned to the broadcasting station; and wherein the content list comprises a channel assigned to the transmitter and/or a transmitter's group having transmitted the content data acquired by the network connection unit.

According to the construction described above, content data can be divided into each sender and/or each group of senders, and can be dealt by specifying a channel, and even in situation that a lot of content data is received by more than one person, a receiver can easily find target content data. Convenience can be improved and operations can be easier.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram, illustrating of a content-recording apparatus in a first embodiment of the present invention;

FIG. 2(a) to FIG. 2(c) are illustrations, showing how stored data of a content-recording unit is constructed in the first embodiment of the present invention;

FIG. 3 is an illustration, showing how a correspondence table is constructed in the first embodiment of the present invention;

FIG. 4 is a flowchart, illustrating the content-recording apparatus in the first embodiment of the present invention;

FIG. 5 is the flowchart, illustrating the content display processing of the content-recording apparatus in the first embodiment of the present invention;

FIG. 6 is a descriptive illustration showing how the content-recording apparatus is operated in the first embodiment of the present invention;

FIG. 7 is an explanatory diagram of the content-recording apparatus in the first embodiment of the present invention;

FIG. 8 is a flowchart, illustrating the content-recording apparatus in a second embodiment of the present invention;

FIG. 9 is an explanatory diagram of the content-recording apparatus in the second embodiment of the present invention;

FIG. 10(a) to FIG. 10(b) are explanatory diagrams, illustrating the content-recording apparatus in the second embodiment of the present invention;

FIG. 11 is the flowchart, illustrating the content-recording apparatus in a third embodiment of the present invention;

FIG. 12 is an explanatory diagram, illustrating a content list in the third embodiment of the present invention;

FIG. 13 is an illustration showing how a correspondence table is constructed in a fourth embodiment of the present invention;

FIG. 14 is an explanatory diagram, illustrating the content list in the fourth embodiment of the present invention;

FIG. 15 is a diagram of content data sharing system in the first embodiment of the present invention;

FIG. 16(a) to FIG. 16(d) are explanatory diagrams, showing how the content list is constructed in the fourth embodiment of the present invention; and

FIG. 17 to FIG. 20 are explanatory diagrams, illustrating the content list in the fourth embodiment of the present invention.

### DETAILED DESCRIPTION OF THE PREFERRED EMBODIMENTS

Embodiments of the present invention will now be described with reference to the drawings.

(First Embodiment)

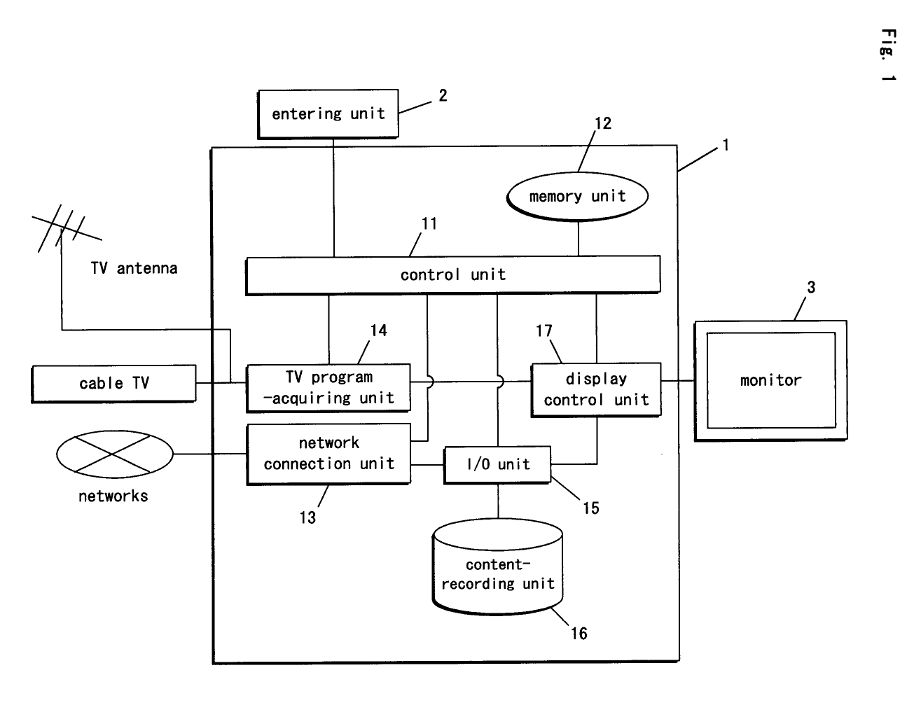

First, the content-recording apparatus in the first embodiment of this invention is explained using FIG. 1 to FIG. 7.

FIG. 1 is a block diagram of the content-reproducing apparatus in the first embodiment of this invention.

As shown in FIG. 1, this content-reproducing apparatus comprises a content-recording apparatus 1 and a monitor 3.

The monitor 3 is the Braun tube, LCD, or plasma display, and performs a display of contents, and reproduction of audio based on the signal outputted from a display control unit 17 of the content-recording apparatus 1.

An entering unit 2 consists of a keyboard, a remote control, etc., and receives command information that a user inputs.

The entering unit 2 is for a user to input button operations, such as changing channels and entering characters.

An I/O unit 15 reads and writes the content data of a content-recording unit 7.

A content-recording unit 16 is nonvolatile medium, such as a hard disk, an optical disk, and a flash memory, and can read and write content data at random.

The content-recording unit 16 needs to be consisted in a way that a control unit 11 can use as a series of storage domains. A combination of a hard disk and an optical disk does not interfere in here.

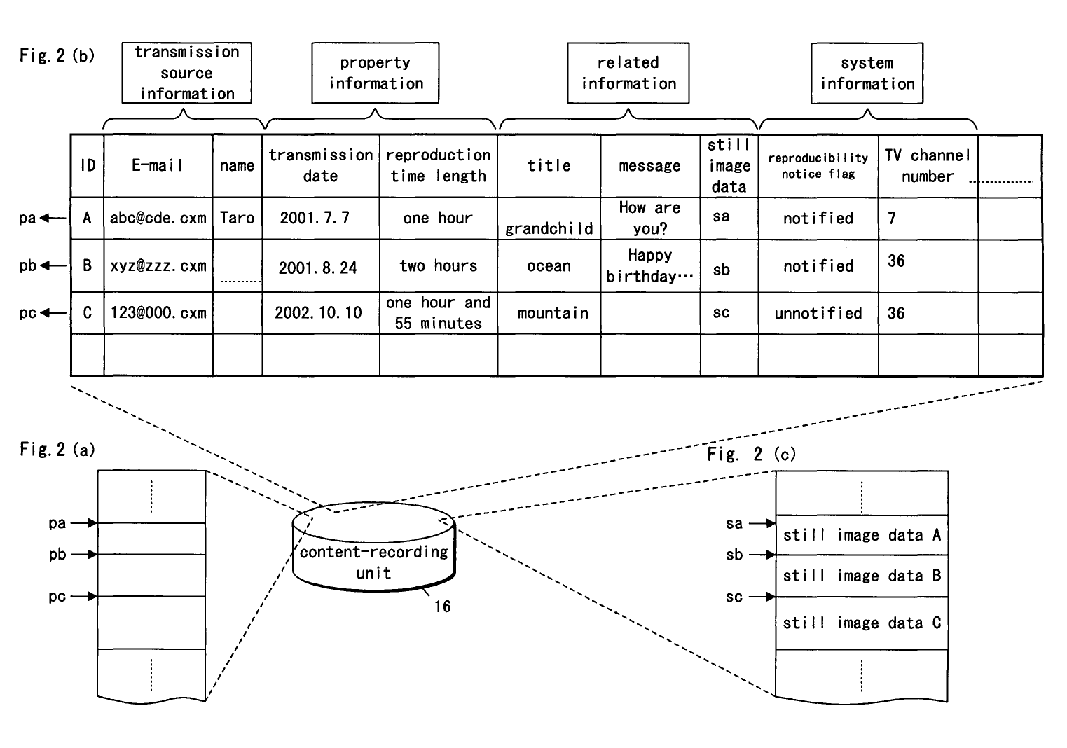

The data structure of the content-recording unit 16 is explained referring to FIG. 2 later.

The control unit 11 consists of CPU (Central Processing Unit), which control each element shown in FIG. 1, and ROM (Read-Only Memory), etc.

The program, which CPU performs according to a flowchart mentioned later, is recorded in ROM.

The control unit 11 searches the content data, indicated by the command information which is received by the entering unit 2, in the content-recording unit 16. When the corresponding content data exists, the control unit 11 demands the display-control unit 17 to generate signals for the monitor 3, based on this content data.

A memory unit 12 consists of RAM (Random Access Memory) etc., and the memory unit 12 secures a domain that the control unit 11 temporarily stores required information for processing.

A part of the memory unit 12 may be used as a cache to the content-recording unit 16.

This content-recording apparatus 1 acquires content data, via the following two routes at least.

A TV program-acquiring unit 14 consists of a TV tuner etc., and follows an instruction of the control unit 11, and then tunes a TV program up from a TV antenna, or receives a TV program of cable TV.

That is, the TV program-acquiring unit 14 acquires content data and EPG-program-table data from a broadcasting station.

A network connection unit 13 acquires content data via a network, such as the Internet. The network connection unit 13 follows an instruction of the control unit 11, and performs, via a network, identification of a connection destination, establishment of a communication session, and acquisition of content data.

Hereafter, the Internet is taken up as a network.

The connection with the Internet just needs to use the existing Internet connectivity technology, such as a dialup connection, and is not related to the main point of this invention. Therefore, the detailed explanation is omitted.

The display control unit 17 receives the content data that is received from the I/O unit 15 or the TV program-acquiring unit 14, and changes the data into content signals that a monitor 3 can display, and then outputs.

When content data is compressed using MPEG and others, the display control unit 17 also comprises a function to elongate the compressed content data.

When the content data, which the network connection unit 13 acquires via the network, is stored in the content-recording unit 16 and is possible to reproduce, the display control unit 17 generates the signals for the monitor 3 which notify a user of the situation (what the sub screen displays in this embodiment).

The detail regarding a processing of the display control unit 17 is also explained using another figure later.

Next, the example of recording content data acquired via the network connection unit 13 into the content-recording unit 16, is explained using FIG. 2.

As mentioned above, the content-recording unit 16 is constructed such that a control unit 11 can use the content-recording unit 16 as a series of storage domains. For example, as shown in FIG. 2(A), the substance of the content data is recorded as Data A, B, C and others.

Here, pa, pb, and pc are pointers, showing the head of Data A, B, and C, respectively.

For example, these Data A, B, C and others are managed by the table shown in FIG. 2(b).

This table has control items of “ID”, the “transmission source information” of the content data, the “property information” of the content data, the “related information” created by the sender and related to the content data, and the “system information” added by this content-recording apparatus.

The “transmission source information” includes the fields, such as an E-mail address, a name, an IP address, and a domain name.

The “property information” includes the fields, such as transmitting time and reproduction time length.

The “related information” includes the fields, such as a title of contents, a message, and a still picture.

The “system information” includes the fields, such as a reproducibility notice flag showing whether a reproducibility notice of the received contents has been displayed or not, and a reproduction flag showing whether the received contents have been reproduced or not.

The field of “ID” is the identifier of various content data, and consists of the name A, B, C, and others, and the pointers pa, pb, pc and others.

Therefore, the control unit 11 can freely access the corresponding content data of the content-recording unit 16 via the I/O unit 15, when this ID is obtained.

Since “ID” just needs to distinguish various content data, the control unit 11 may give and determine itself to become a unique relation for each content data.

The field of “transmission source information” is a data field in order to specify where content data comes from.

When content data is acquired via the Internet, as information of transmission source, the control unit 11 acquires one of the values of an E-mail address, an IP address, a domain name, or a name, and sets the value to the corresponding field.

For example, when content data is sent as an attached file of an E-mail etc., the mail address of a sender is given on the E-mail, and the value is set to the field of an “E-mail address.”

By a file communication such as ftp etc., when content data is acquired, the value of the “IP address” and the “domain name” which are the transmission destination is set to the corresponding field.

The field of “property information” is a data field showing the property of content data and the feature.

The control unit 11 measures the size of the content data recorded on the content-recording unit 16, a reproduction time length, etc. from the content data, and sets the value to the corresponding field.

The control unit 11 measures a time starting a reception of data, and the value is set to the corresponding field.

Each field of “related information” is a data field where the information added to content data is set by the sender.

When the content-recording apparatus 1 acquires content data, data created by the transmission source is also acquired. The control unit 11 acquires the contents attached to the content data, such as a title, a message, a still picture data, and a sound data, out of the data, and sets the value to the corresponding field.

When multimedia data, such as a still picture data and a sound data, is acquired as related information, the control unit 11 records the multimedia data of the content-recording unit 16, just like content data, and acquires the pointers of the recorded multimedia data, and sets these pointers to each field.

For example, as shown in FIG. 2(c) still picture data A, B, C and others are recorded on the content-recording unit 16, and sa, sb, sc and others are pointers of the head of the still picture data A, B, C and others, respectively. The values of these pointers are stored in the still picture field of related information.

This pointer can be arbitrarily changed, if the pointer is an identifier that specifies the multimedia data to record.

A concrete example of setting “related information” in a field is given.

When content data is sent as an attached file of an E-mail etc., an E-mail subject is set in a data field as a “title”, and contents of a text are set in a data field as a “message”.

The still picture and audio attached in addition to the content data are stored in the content-recording unit 16, and the pointer is set to each data field.

The data added by the transmission source may be integrated as a part of the content data.

The field of “system information” is a data field where the system information of the content data is set, such as whether the content data has been reproduced and the reproducibility notice has been displayed.

The control unit 11 sets information, which is necessary for a program of a system.

The value of each above mentioned field may be omitted appropriately and another field may be added.

As illustrated, one of or more than one of a title, a message, the information that indicates a sender, a sending date, a receiving date, a reproduction time length and a data size better be provided, or a field of a TV channel number better be provided.

Of course, each sequence of the field can be changed appropriately.

Each field does not need to be entirely filled up.

The classification of each field, such as transmission source information, property information, related information, and system information, is an expedient in order to explain, and the point of a classification can be changed appropriately.

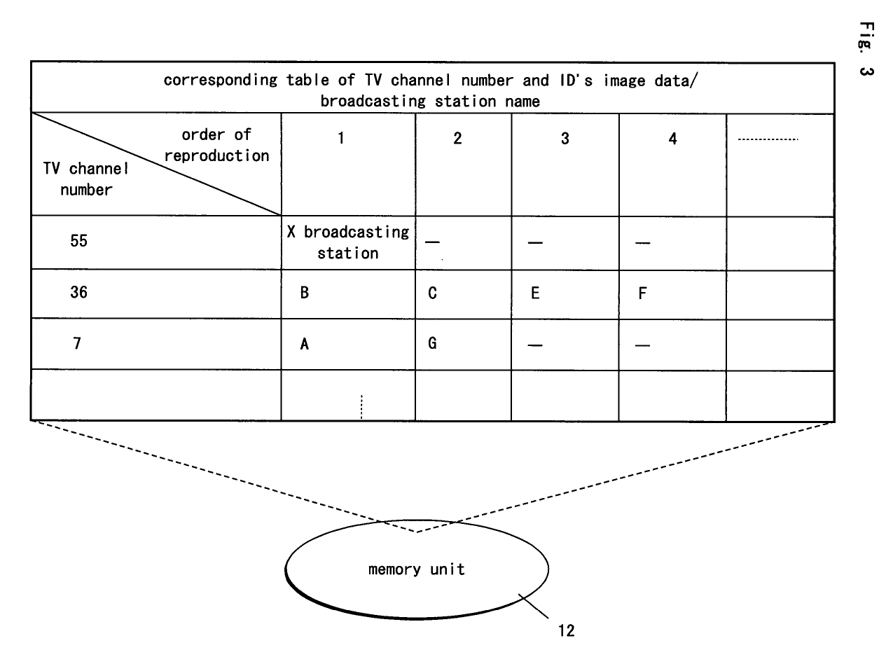

As illustrated in FIG. 3, the memory unit 12 provides a correspondence table which associates a TV channel number, and ID or the TV broadcast station name of content data.

In the example of FIG. 3, ID of content data or the field of a TV broadcast station name is defined for every TV channel number as an item of the correspondence table of the content data, which is received via the network.

This table is used in order to determine which content data the control unit 11 outputs when selection of a TV channel number is made from the entering unit 2.

In this example, as for the content data received via the network connection unit 13, the value of ID of content data is set into the field of the assigned TV channel number.

In the content data (a TV program) received via the TV program-acquiring unit 5 sets, a name of a TV broadcast station broadcasting the program is set into the field of the assigned TV channel number.

The information set in the field of a TV broadcast station name does not necessarily need to be the TV broadcast station name itself, just needs to be an identifier indicating a TV broadcast station.

For example, when a TV channel number “36” is inputted from an entering unit 2, the control unit 11 searches a table in the memory unit 12, acquires ID of the content data corresponding to the entry that is the TV channel number “36”, and takes out the content data from the ID.

Thus, the reproduction of the content data is performed.

In the example of FIG. 3, content data B, C, E, and F are reproduced in this order.

As shown in FIG. 2(b), each TV channel number is also set in the field that is the “TV channel number”, in the table of the content-recording unit 16.

For example, when a TV channel number “55” is inputted from the entering unit 2, the control unit 11 outputs the TV program of the broadcasting station corresponding to the entry whose TV channel number is “55.”

In this TV channel number and ID of the content data, or a correspondence table with a broadcasting station name, the value of each field may be omitted appropriately and another field may be added.

Of course, each sequence of the field may be changed appropriately.

Each field does not need to be entirely filled up.

In short, one or more than one of the content data or TV broadcast stations may be specified to the TV channel number.

A user may edit the contents of these tables using the entering unit 2.

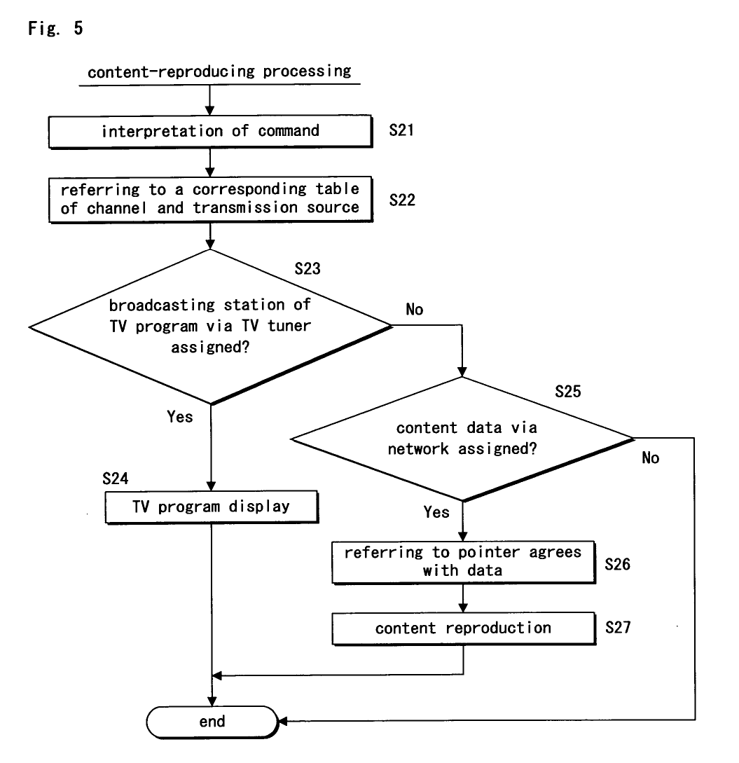

Operations of the content-recording apparatus constructed as mentioned above are explained, referring to FIG. 5.

First, in Step S1 of FIG. 5, when the Internet connection processing is started, the control unit 11 gives the network connection unit 13 a connection instruction to the Internet, and the network connection unit 13, which received the instruction, starts connection with the Internet.

When this connection is completed, the content-recording apparatus 1 is ready to start communication on the Internet (access to a Web server, acquisition of an E-mail, etc.).

In Step S2, the control unit 11 performs an event surveillance processing.

Three events (1) user input, (2) content upload on a Web server, and (3) arrival of E-mail with content data, are kept under surveillance.

A certain period of time is assigned for each processing.

When one of the events occurs in these three kinds of surveillance, the processing progresses to Step S3.

The class of the event is judged in Step S3.

When content upload or arrival of E-mail with content data occurs, the event is defined as an event with content data, and the processing progresses to Step S4. When the other processing, for example, entering processing from user occurs, the processing progresses to Step S7.

Contents are stored in Step S4.

When content upload is detected, the control unit 11 downloads the contents from the Web server on the Internet via the network connection unit 13, and writes the content data in the content-recording unit 16 via the I/O unit 15.

When arrival of E-mail with content data occurs, the control unit 11 takes out a part of content data of the data, and writes the content data in the content-recording unit 16 via the I/O unit 15.

In Step S5, the control unit 11 acquires the information about the content data, and saves content management data in the content-recording unit 16 and the memory unit 12 via the I/O unit 15, and the processing progresses to Step S6.

The processing of a recording processing of contents now ends.

In Step S6, the control unit 11 acquires required data from the memory unit 12, and orders a display control unit 17 to perform generation of a sub screen.

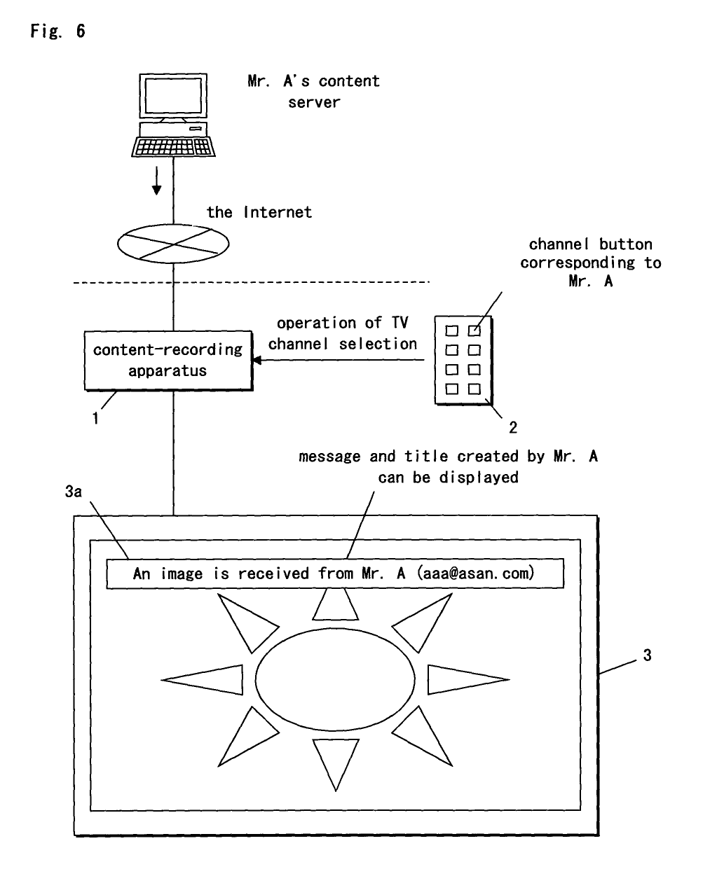

On the other hand, as illustrated in FIG. 6, the display control unit 17 generates the sub screen 3a that informs a user of the readiness of reproduction of the content data. The display control unit 17 generates a signal of a screen which that the sub screen 3a is overlapped with the main screen (screen presently displayed), and then outputs this signal to the monitor 3.

If there is information (for example, the still picture of a representative screen, the digest version of content data, etc.) relevant to the corresponding content data recorded in the content-recording unit 16, it is desirable to choose this information appropriately, and to display for the screen 3a.

The sub screen 3a may include a “name”, an “E-mail address”, etc. which are transmission source information, as shown in FIG. 6.

When the processing of Step S6 is completed, the processing progresses to Step S8.

In Step S7, when a user does not give an instruction, the processing moves to Step S8, and when a user gives an instruction, all the processing is completed.

In Step S8, whether or not stored recording data exists is judged. When the stored recording data does not exist, the processing is returned to Step S2.

Otherwise, the content display processing of Step S9 is performed.

In this embodiment, the sub screen 3a operable to perform the reproducibility notice was overlapped with the main screen, and displayed, but it may be displayed on a sub window or a simple LED attached to a content-recording apparatus, and the method of a display can be changed appropriately.

The notice by audio may be used together.

In this specification, the “sub screen” is defined in a broad sense than usual meaning. The sub screen does not need to contain the continuous tone of the ground inside borders or borders etc., as illustrated to FIG. 6.

For example, this “sub screen” includes subtitles, which has a transparent background and are composed of only characters, and without borders.

A notice may be performed by only audio while not displaying a sub screen at all.

Next, the content display processing of Step S9 is explained in detail using FIG. 5.

In Step S21, the control unit 11 analyzes the command entering from the entering unit 2.

In this embodiment, a relation is “command=a selected channel”, and the control unit 11 handles the inputted number as a selected channel.

In Step S22, the control unit 11 acquires content-management-data ID or a broadcasting station name referring to the correspondence table of the memory unit 12.

In Step S23, when the item assigned to TV channel number is a broadcasting station name as a result of Step S22, the processing progresses to Step S24.

Otherwise, the processing progresses to Step S26.

In Step S24, the control unit 11 acquires the content data (a TV program) on the air, which is corresponding to the broadcasting station name acquired in Step S22 via the TV program-acquiring unit 14. This content data is displayed on the monitor 3.

In Step S25, when the TV channel number acquired in Step S22 is ID of the content data acquired via the network, the processing progresses to Step S26, and otherwise, the processing is ended.

In Step S26, the control unit 11 refers and acquires a pointer indicating the ID, which is acquired from content-management-data ID in Step S22, and the processing progresses to Step S27.

In Step S27, content data is specified based on the pointer information of the content data, the specified content data is passed to the display control unit 17 via the I/O unit 15. The display control unit 17 reproduces the data, and outputs the data to the monitor 3.

Thereby, the assigned content data is displayed on the monitor 3.

At this time, the control unit 11 eliminates the contents of the memory unit 12, and then eliminates the sub screen which tells the reproducibility notice displayed on the screen.

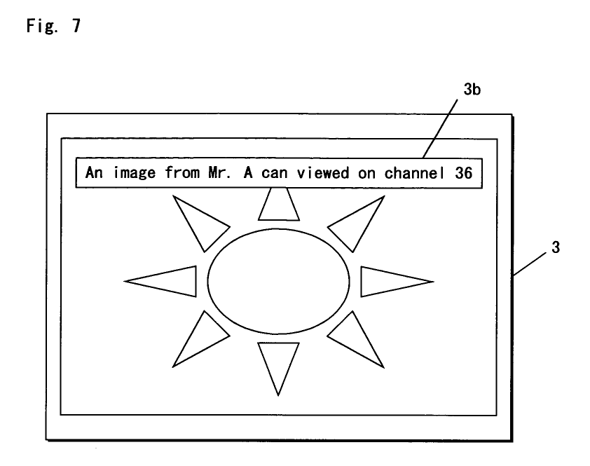

A descriptive illustration of the operations in this embodiment is explained, referring to FIG. 7.

FIG. 7 indicates the situation where the monitor 3 displays the sub screen 3a indicating that the content data that is uploaded on the content server on the Internet is stored in the content-recording apparatus 1 and is reproducible.

In the example of FIG. 6, the content-recording apparatus 1 receives content data from Mr. A's content server, and the content data is reproducible.

At this time, the content-recording apparatus 1 piles up the sub screen 3a, including information of Mr. A (that is the transmission source), and the title and the message that Mr. A creates, with displayed contents (a main screen) on the monitor 3. The content-recording apparatus 1 notifies a user of the existence of the received content data.

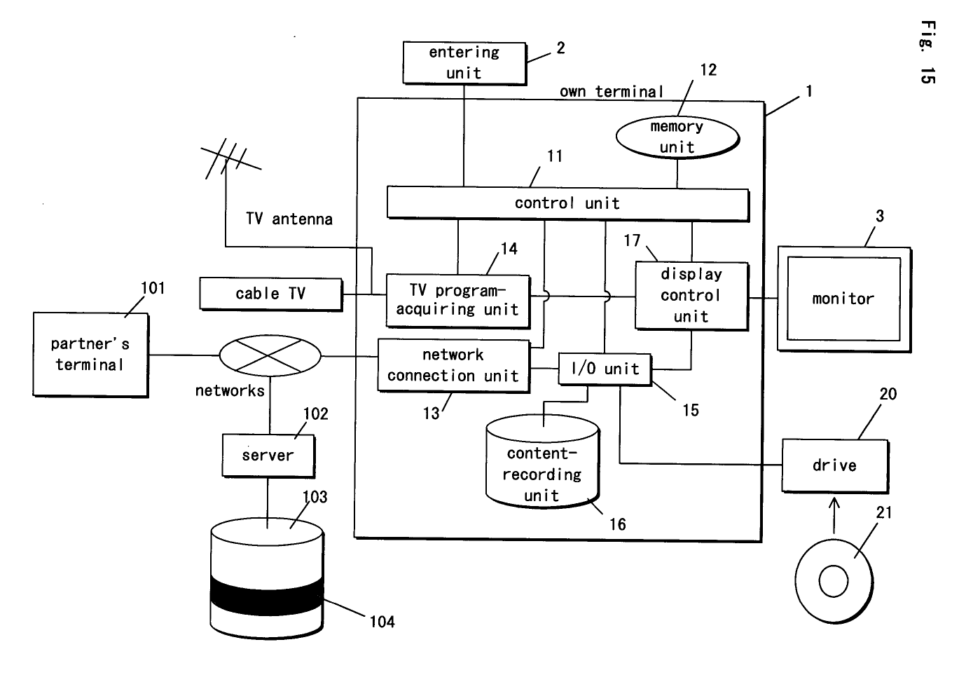

The example using the server, which exists on a network, is described using FIG. 15.

As shown in FIG. 15, a server 102 exists on a network 100.

The server 102 is connected to a recording apparatus 103 which is composed of a mass hard disk drive apparatus etc.

The certain domain of the recording apparatus 103 is a shared domain 104, which is opened to the specific user, who is permitted to access to the server 102.

An own terminal 1 and a partner's terminal 101 can send and receive content data via the shared domain 104.

In this case, the partner's terminal 101 of a transmitting side uploads content data to the shared domain 104 of the server 102.

The own terminal 1 of a receiving side can download content data from the shared domain 104 of the server 102, and can reproduce.

A drive 20 is connected to the I/O unit 15, and a recording medium (for example, CD-ROM etc.) 21 is set to the drive 20.

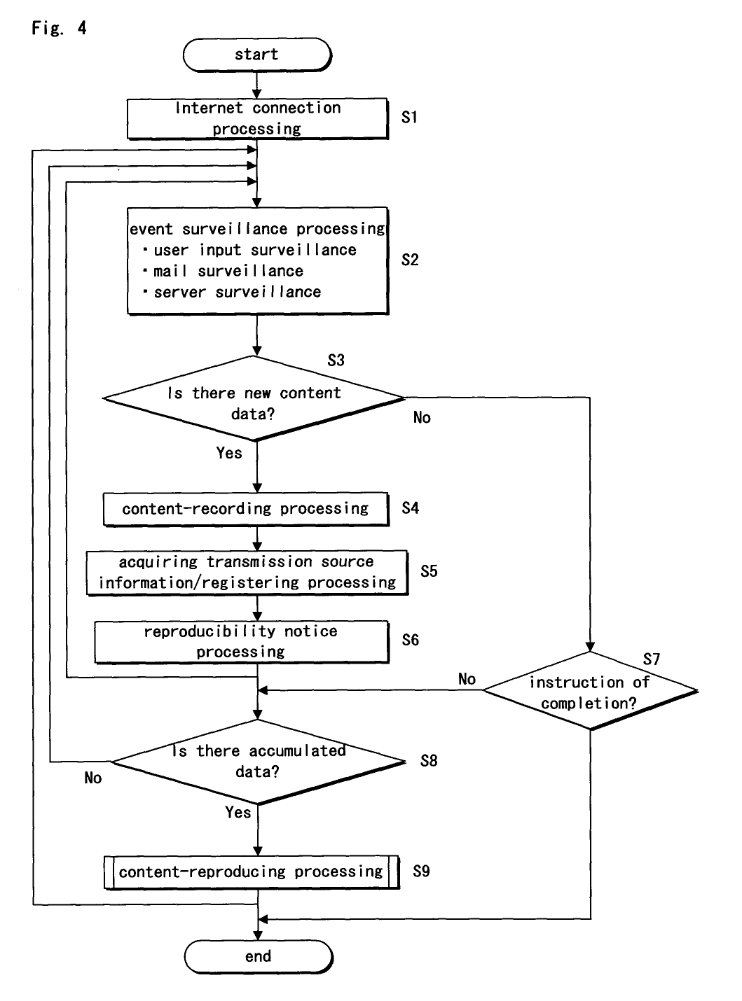

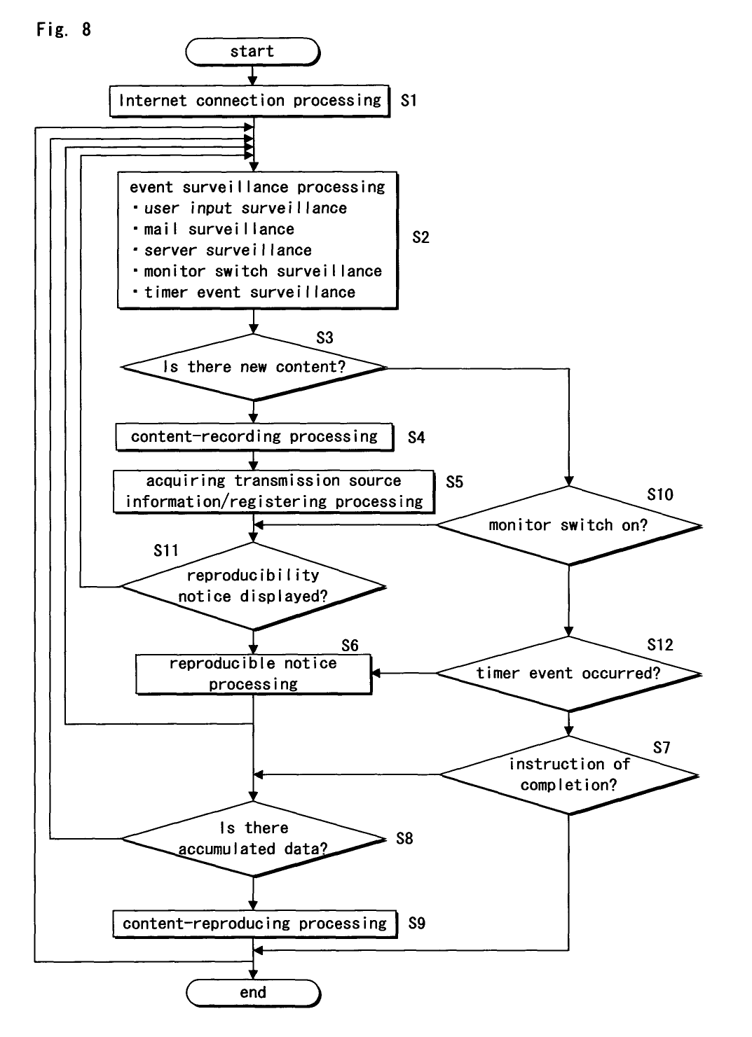

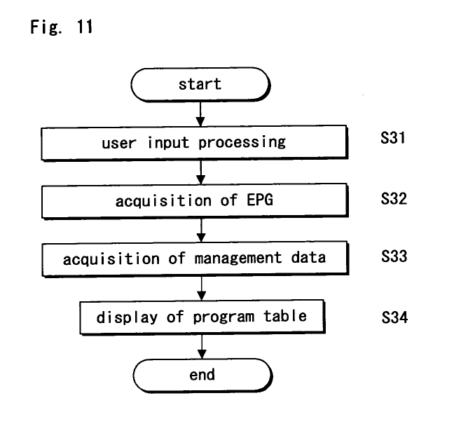

The content-recording program according to the flowcharts such as shown in FIG. 4, FIG. 5, FIG. 8, and FIG. 11 is stored in the recording medium 21. The control unit 11 loads this program into the memory unit 2, installs it in the content-recording unit 6, and performs this program.

As shown in FIG. 7, it is more convenient, if a TV channel number, on which contents can be viewed and listened to, is recorded on the sub screen 3b.

At this time, a user can view and listen to the desired content data (contents of Mr. A) when the user inputs a TV channel “36” displayed using the entering unit 2.

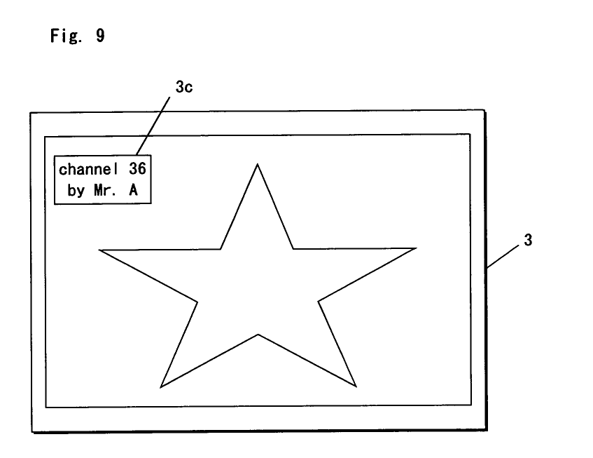

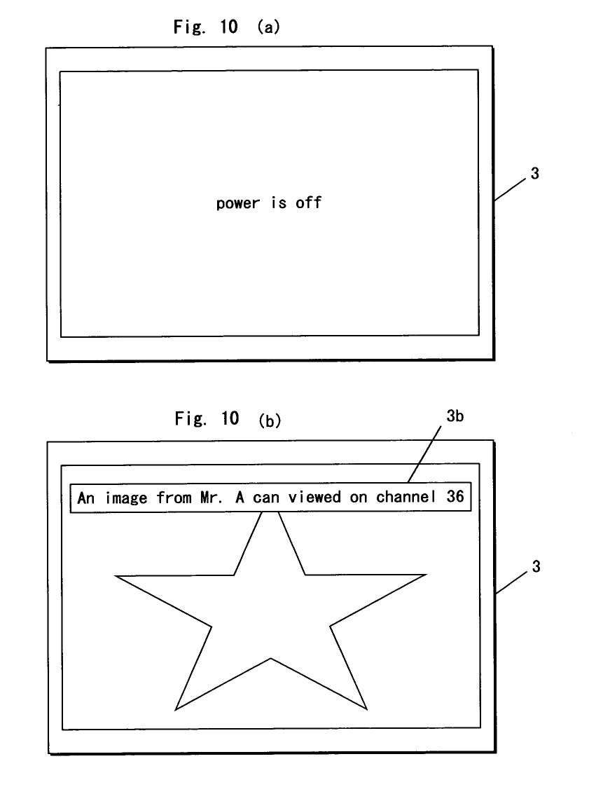

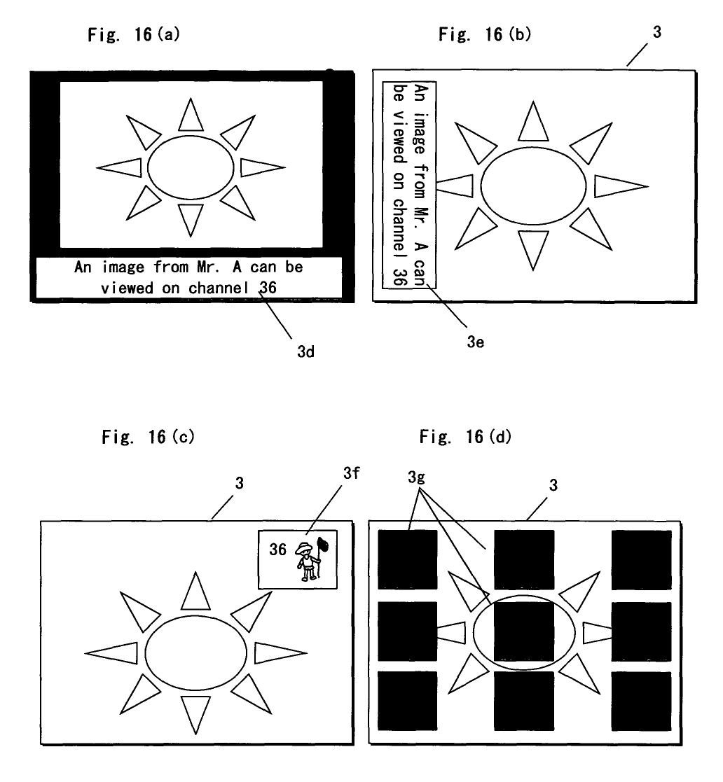

An explanatory diagram, which is different from FIG. 6, FIG. 7, FIG. 9, and FIG. 10, is explained using FIG. 16.

In FIG. 16(a), a sub screen 3d is not overlapped with a main screen, but is displayed on a separated domain from the main screen.

In FIG. 16(b), a sub screen 3e is formed taller than it is wide, and the message is displayed in vertical writing.

In FIG. 16(c), a preview of contents, and a channel number (36) to which contents are assigned, are displayed on a sub screen 3f,

In FIG. 16(d), positions that a display of a sub 3g screen can be located are illustrated.

That is, the sub screen 3g may be displayed in any position, as displayed in FIG. 16(d).

A user's attention may be attracted more by using different display forms than usual ones. Different display forms are such as moving the sub screen 3g, changing the shape of the sub screen 3g, and changing the brightness of the whole screen (for example, suddenly brighten up as if a flash is on, and blinking).

In short, notifying a user that the contents are reproducible is the point of the present embodiment.

For example, a message can be reproduced with only audio while not displaying a sub screen. An easier way is reproducing specific music (without vocal sound), or reproducing a beep and a buzzer, and this method can acquire some effects in its own way.

(Second Embodiment)

A second embodiment is explained using FIG. 8 to FIG. 10.

Only difference with the first embodiment is described hereafter.

FIG. 9 is a flow chart of a content-recording apparatus in the second embodiment of the present invention.

The flow chart shown in FIG. 9 has the following difference from the flow chart shown in FIG. 4 in the first embodiment.

First, a surveillance of the switch (ON/OFF) of the monitor 3 and surveillance of a timer event are newly added to an event surveillance processing of step S2.

Under the surveillance of the switch of the monitor 3, the control unit 11 acquires the situation of the switch of the monitor 3 through the display control unit 17.

Although ON (the display is performed) and OFF (the display is not performed) are present in the following description of the situation of the switch, the condition of standby shall be included in OFF.

Under the surveillance of the timer event, if the control unit 11 sets the timer event, after passing arbitrary time, the control unit 11 generates an event.

In step S5, the value showing “un-notifying” is put into the “reproducibility notice flag” field shown in FIG. 2(b), and is saved at the content-recording unit 16.

In step S110, whether the switch of the monitor 3 is turned on is judged.

When the switch of the monitor is ON, the processing goes to step S11, otherwise, the processing goes to step S12.

In step S11, the control unit 11 judges whether the condition which should display a reproducibility notice is fulfilled.

The above condition is that the switch of the monitor 3 is ON, and that the content management data exists in the table of the content management data stored in the content-recording unit 16. The content management data is a “reproducibility notice flag” which “has not notified.”

If this condition is fulfilled, the processing goes to step S6, otherwise, the processing returns to step S2.

In step S12, the control unit 11 distinguishes whether the timer event is generated. When the timer event is generated, the processing goes to step S6. If the timer event is not generated, the processing goes to step S7.

In step S9, when the content data via a network to which the reproducibility notice was given is reproduced, the control unit 11 makes the “reproducibility notice flag” of this content management data “notified”, and saves the data in the content-recording unit 16, and eliminates the contents of the memory unit 12.

In the second embodiment, the display control unit 17 performs the following processing by making generation of a timer event into a trigger.

As shown in FIG. 7, when a certain period of time passes after piling up and displaying the sub screen 3b on the main screen, as shown in FIG. 9, the sub screen 3c is generated by reducing the sub screen 3b, and this reduced sub screen 3c is piled up and displayed on the main screen.

Since the number of characters which can be displayed on the sub screen generally becomes fewer with reduction of the sub screen size as illustrated, it is desirable to change the message in the sub screen into a briefer expression.

In the second embodiment, as shown in FIG. 10(a), when a power supply changes to ON from the state where the power supply of the monitor 3 is off as shown in FIG. 10(b), the following processing is performed by making step S10 of FIG. 8 into a trigger.

In the second embodiment, during OFF of the power supply of the monitor 3, the content data which the network connection unit 13 acquires via a network is recorded on the content-recording unit 16 and becomes reproducible, and when a display of the monitor 3 is started, the sub screen 3b which shows the purport that the content data can be reproducible is displayed.

The display control unit 17 outputs a signal to the monitor 3 so that the above mentioned condition may be fulfilled.

By such arrangement, a user can see an initial sub screen 3b (FIG. 7) rather than can see the sub screen 3c (FIG. 9) which changed in accordance with time.

(Third Embodiment)

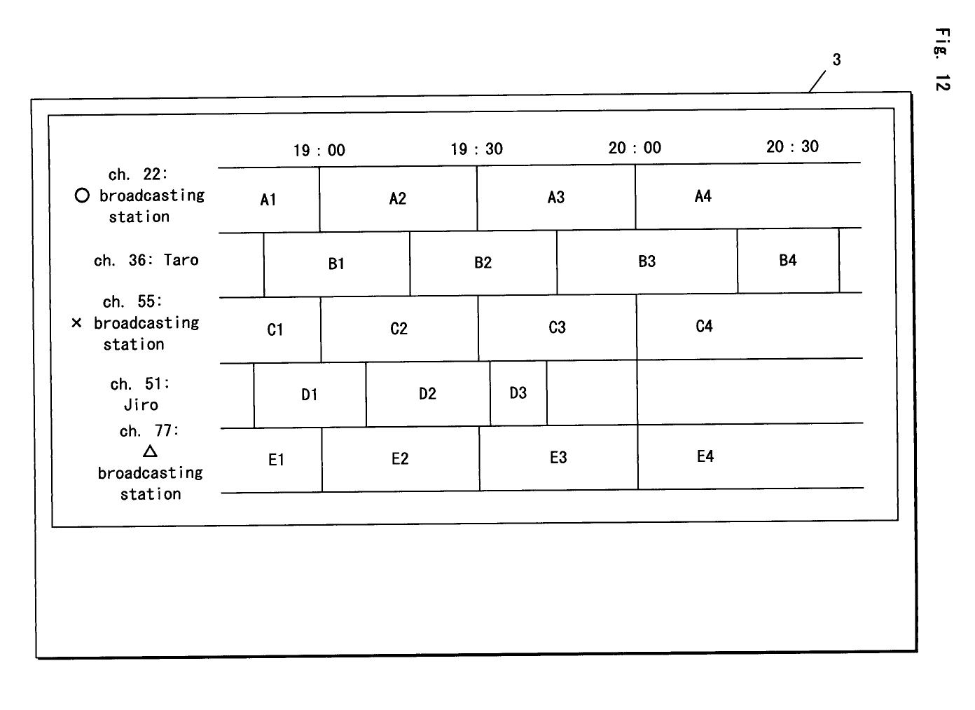

A third embodiment of this invention is explained using FIG. 11 to FIG. 12.

Only difference with the first embodiment is described hereafter.

The construction of the content-recording apparatus in the third embodiment is the same as that of the first embodiment shown in FIG. 1.

In the third embodiment, a TV program-acquiring unit 14 acquires EPG (Electronic Program Guide) information which shows the broadcast schedule of TV program from a broadcasting station, and the control unit 11 analyzes the EPG information.

The EPG information can also be acquired via the network connection unit 13.

Next, operation of the content-recording apparatus in the third embodiment is explained, referring to FIG. 11.

First, in step S31, the control unit 11 acquires input information of a user by inputting command information from the entering unit 2.

When a user chooses to display a TV channel program table by using the entering unit 2, a processing proceeds to step S32.

In step S32, the control unit 11 acquires the EPG information from a broadcasting station via the TV program-acquiring unit 14 or the network connection unit 13.

The control unit 11 stores the acquired EPG information in the memory unit 12.

In step S33, the control unit 11 acquires the ID of the content data currently assigned to TV channel number from the ID of the TV channel number and the content data, or a correspondence table with a TV broadcast station name, acquires the content management data corresponding to the content data ID from the content-recording unit 16, and stores the content management data in the memory unit 12.

Above, the content data ID is used as a search key.

The control unit 11 acquires the TV broadcast station name currently assigned to TV channel number from the ID of the TV channel number and the content data, or the correspondence table with the TV broadcast station name, acquires a TV program information broadcast in the TV broadcast station with reference to the EPG information on the memory unit 12, and stores the TV program information in the memory unit 12.

In step S34, as illustrated in FIG. 12, the control unit 11 creates data of a content list. The TV channel number is plotted on either side of a vertical axis or a horizontal axis, and time is plotted on the other side of the vertical axis or the horizontal axis.

As shown in FIG. 12, the data of the content list is not limited to the one that is arranged from what has been received from the broadcasting station as mentioned above. The control unit 11 equivalently treats the content list of the content data (TV program) acquired by the TV program-acquiring unit 14 and the content list of the content data acquired by the network connection unit 13.

In the example shown in FIG. 12, the TV channel number is taken along the vertical axis, and the time is taken along the horizontal axis.

A 22 channel is assigned to “O broadcasting station,” a 36 channel is assigned to “Mr. Taro,” a 55 channel is assigned to “x broadcasting station,” a 51 channel is assigned to “Mr. Jiro”, and a 77 channel is assigned to “□ broadcasting station,” respectively.

Data A1, A2, and others are content data of a TV program of the O broadcasting station.

Data B1, B2, and others are content data received from Mr. Taro, and the following is the same.

There may be a time zone when the corresponding content data does not exist like after 19:40 minute of the 51 channel.

There may be nothing about a broadcasting station in the portion displayed among the content lists, all may become the display of a transmission source, and the data of a corporation may be assigned to a specific channel.

Only a channel number may also be displayed in FIG. 12.

A program table displayed on the monitor 3 which is illustrated in FIG. 12 cannot remain in a mere display, and can be also used it as a user interface for selection, edit, recording, etc. like the conventional EPG by using the entering unit 2 together.

Thus, even if a user is unfamiliar to a computer, by seeing the content list as shown in FIG. 12, the user can use the content data via a broadcasting station and the content data via a network, gently, seamlessly, and without distinguishing the content data intentionally.

(Fourth Embodiment)

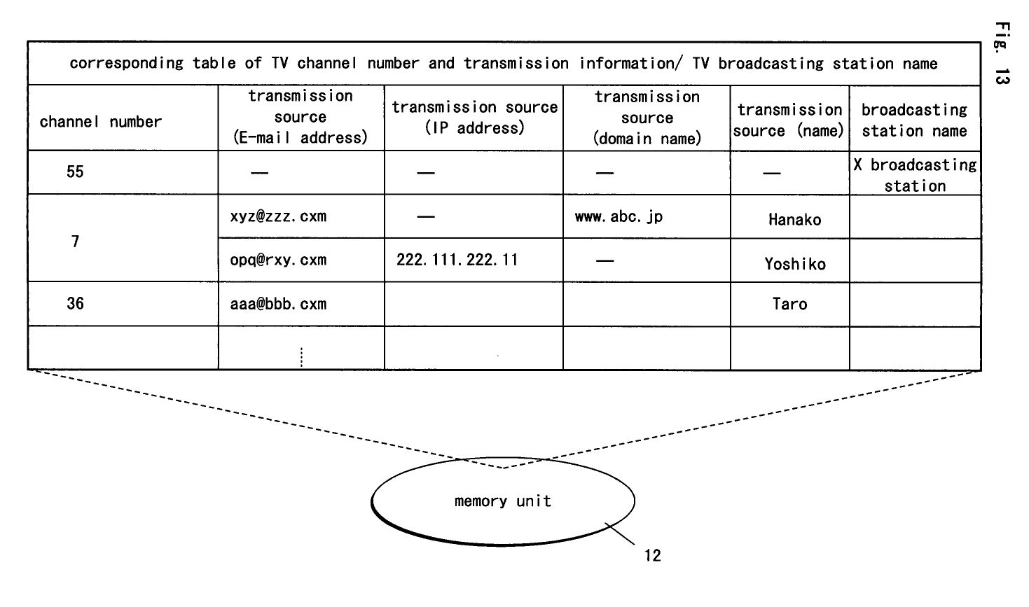

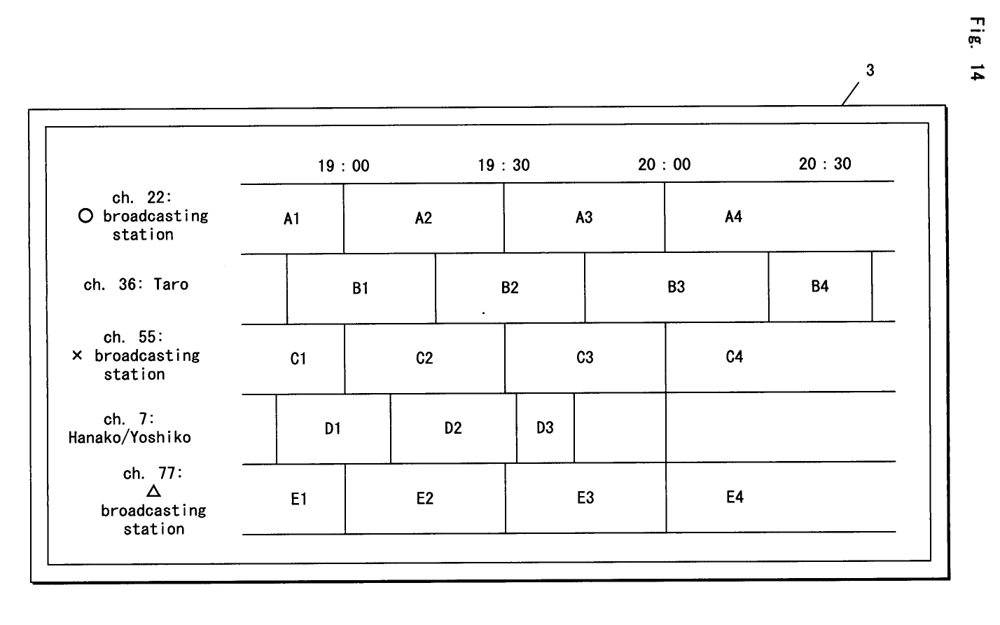

A fourth embodiment of this invention is explained using FIG. 13 to FIG. 14.

Only difference with the third embodiment is described hereafter.

Referring to FIG. 13, in the fourth embodiment, transmission source information of TV channels and content data memorized in the memory unit 12 of a content-recording apparatus or a correspondence table with a TV broadcast station name is explained.

In the present embodiment, when selection of a TV channel number is performed from the entering unit 2, a table for the control unit 11 to judge which content data to output is prepared in the memory unit 12.

In a case of the content data received via the network connection unit 13, a field of the transmission source information of the content data is defined, in a case of TV program received via the TV program-acquiring unit 14, a field of a TV broadcast station name is defined, for every TV channel number, as an item of the correspondence table of the content data displayed as the TV channel number.

The field of the TV broadcast station name is no need of being a TV broadcast station name but should just be an identifier indicating the TV broadcast station.

In an example of FIG. 13, the channel 55 is assigned to the “x broadcasting station,” the channel 7 is assigned to “Ms. Hanako and Ms. Yoshiko group,” and the channel 36 is assigned to “Mr. Taro” with an e-mail address “aaa@bbb.cxm,” respectively.

Next, a use of this table is explained concretely.

When a TV channel number “36” is inputted by the entering unit 2, the control unit 11 acquires transmission source information (that is “aaa@bbb.cxm”) of the content data of the entry whose TV channel number is “36.”

The control unit 11 searches the content data corresponding to the value of the acquired transmission source information from the content management data recorded in the content-recording unit 16, and the searched content data is reproduced by the I/O unit 15, the display control unit 17, and the monitor 3.

In the example of FIG. 13, when the TV channel number “36” is chosen, the content data whose transmission source information is “aaa@bbb.cxm” is to be searched and reproduced from the content-recording unit 16.

In the above prosess, the transmission source information is used as a search key.

When a TV channel number “55” is inputted by the entering unit 2, the control unit 11 acquires a broadcasting station name “x broadcasting station” corresponding to an entry whose TV channel number is “55.”

The control unit 11 orders the TV program-acquiring unit 14 reception of a TV program of the acquired broadcasting station name (that is “x broadcasting station”), and this TV program will be displayed on the monitor 3.

In a correspondence table with this TV channel number and the transmission source information of the content data, or with the broadcasting station name, the value of each field may be omitted appropriately and another field may be added.

Of course, each sequence of the field can be changed appropriately.

Each field does not need to be entirely filled up.

Transmission source information or a TV broadcast station only needs to be assigned to the TV channel number.

A user may make the contents of these tables possible to change.

To one TV channel number, plural transmission source information may be defined, or the plural transmission source may be collectively assigned like “Ms. Hanako and Ms. Yoshiko group” as in the channel 7.

Operation of the content-recording apparatus in the fourth embodiment is almost the same as that of shown in FIG. 12.

In step S33, the control unit 11 acquires the transmission source information of the content data assigned to the TV channel number or the broadcasting station name, from the correspondence table with the TV channel number and the transmission source information of the content data, or with the TV broadcast station name.

In the above process, the difference is that the transmission source information of the content data or the broadcasting station name substituting the transmission source information are assumed as a search key.

FIG. 14 shows the example of a display of the monitor by the present embodiment.

As mentioned above, unlike the third embodiment, the display reflects that plural transmission sources (that is “Ms. Hanako and Ms. Yoshiko group”) are assigned to the channel 7.

In FIG. 14, only a channel number may be displayed.

In a content list of the present embodiment, a channel is included which is assigned to a sender and/or a group of the senders who sent the content data.

In this way, the content data can be distinguished for each sender and/or each group of senders.

Even when much content data is received from plural transmission sources, a receiver can easily search the content data only by inputting the command of directing the channel from the entering unit 2.

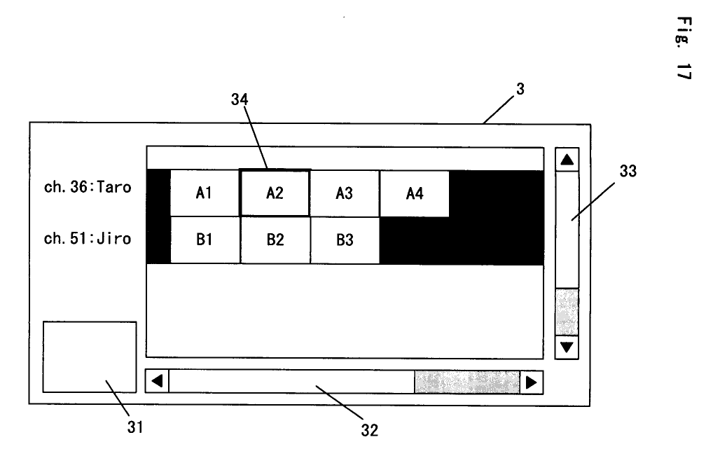

Next, a further example of a content list is explained using FIG. 17 to FIG. 20.

In FIG. 17, a vertical axis of the content list is a channel number axis. The channel number axis is constructed so that a transmission source can be assigned.

A horizontal axis of the content list is an axis showing the order of reproduction of contents.

A vertical scroll bar 33 is placed along a vertical axis, and a horizontal scroll bar 32 is placed along the horizontal axis.

When the vertical scroll bar 33 and the horizontal scroll bar 32 are placed, it is easy and convenient to choose a target when there are many numbers of channels and contents.

In an example of FIG. 17, the 36 channel is assigned to “Mr. Taro,” and a sender of data A1 to A4 is Mr. Taro.

When a user chooses the 36 channel using the entering unit 2, the content data A1, A2, A3, and A4 from Mr. Taro, is reproduced in order.

Similarly, the 51 channel is assigned to “Mr. Jiro,” and a sender of data B1 to B3 is Mr. Jiro.

When a user chooses the 51 channel using the entering unit 2, the content data B1, B2, and B3 from Jiro, is reproduced in order.

Thus, by setting one axis of the content list as the channel number assigned to a sender of the content data, and setting the other axis of the content list as the order of reproduction of the content data, a user can easily understand the point where the content data is reproduced for which channel and in what kind of order.

In the example of FIG. 17, a small content information screen 31 is additionally set up, compared with FIG. 12.

A position for setting up the content information screen 31 is arbitrary.

Currently chosen contents 34 are highlighted, and information regarding the contents 34 is displayed on the content information screen 31.

As information regarding the contents, the representative image (a dynamic image or a still picture is sufficient) of the contents, sender information (a name, an address, etc.), time information (shot time, transmitting time, receiving time, etc.), comment information (a sender's message etc.), the attribute information on contents (data size, a recording method, reproduction time, etc.), or suitable combination of the above described items can be considered.

When the information about such contents is attached and displayed on a content list, it is preferred that a user can understand the details of the contents easily.

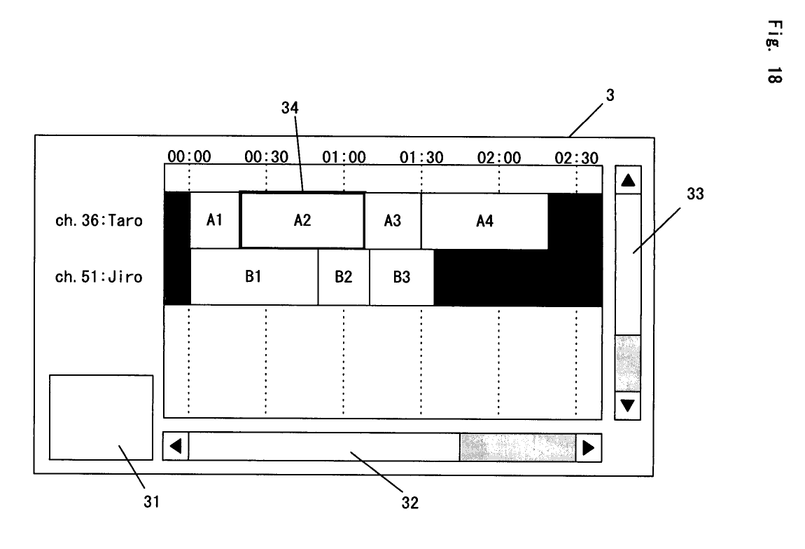

In FIG. 18, differed from FIG. 17, a horizontal axis shows a reproduction time of contents.

That is, the length of the horizontal axis is almost proportional to the reproduction time.

Thus, it is preferred that a user can grasp the reproduction time intuitively.

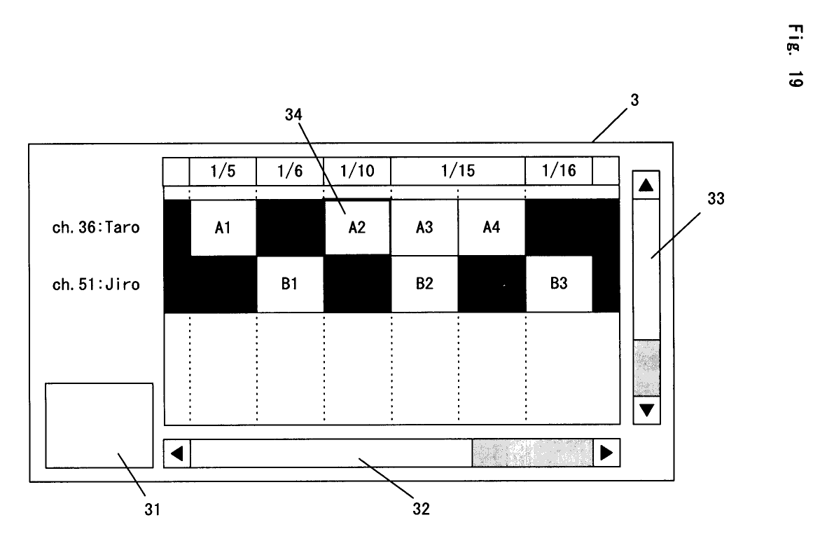

In FIG. 19, differed from FIG. 18, a horizontal axis shows a receiving day of contents (per day).

Therefore, the length of the horizontal axis is not proportional to reproduction time.

For example, two content data (that is contents A3 and contents A4), are received from “Mr. Taro” on January 15.

At this time, the notations located in a line with “A3” and “A4” shows a receiving sequence of the contents A3 and the contents A4.

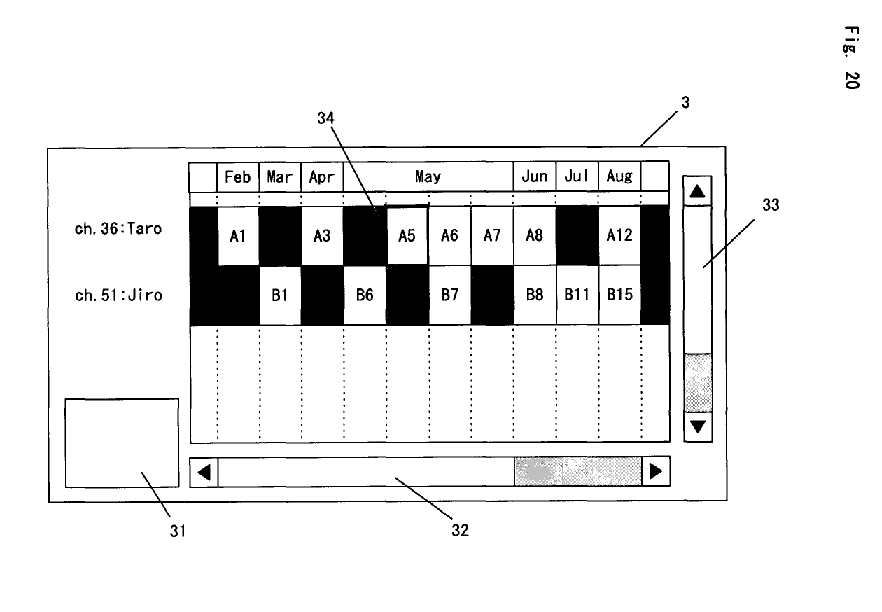

In FIG. 20, differed from FIG. 19, a horizontal axis shows a receiving month of contents (per month).

Therefore, the length of the horizontal axis is not proportional to reproduction time.

For example, three content data of A7 are received from contents A5 by “Mr. Taro” in May.

Notations located in a line with “A5,” “A6,” and “A7” shows a receiving sequence of A7 from the contents A5.

That is, in an example of FIG. 20, the content data received in May are all displayed in the receiving sequence.

On the other hand, as for data received in February to April, and data received in June to August (that is in May or thereabouts), only representative contents (for example, contents with the oldest reception time) are displayed on a content list, and non-representative contents are not displayed on the content list.

When the non-representative contents exist in the month concerned, the non-representative contents are only hidden on the reverse side of the representative contents on the content list.

Therefore, when a user chooses April from the state of FIG. 20, the contents A3 that is the representative contents of April and the non-representative contents A4 hidden on the reverse side thereof will be displayed in order of reception on the content list.

A selection method of the representative contents when plural contents exist in the month concerned is arbitrary.

For example, the selection method of the representative contents can be changed variously, other than above, such by considering contents received at the last as representative contents, or by considering contents with the longest reproduction time as the representative contents.

In FIG. 20, only the contents of the selected month are displayed in detail, and the contents of the month which is not selected are simplified or omitted and displayed.

Thus, a user can see the contents of a longer period in a single content list, and can acquire the detailed content information regarding the month to refer to.

The display configuration of the content list mentioned above may be appropriately changed according to a user's input.

According to the content-recording apparatus of this invention, since content data received from a network, such as the Internet, only by carrying out channel selection operation by the entering unit is reproducible by a monitor, a user can view and listen to contents by simple operation.

Since it is possible to notify a user that the content data received via the network, such as the Internet, became reproducible, just in time when the content data becomes reproducible, the user can surely view and listen to the content data acquired via the network, without overlooking.

Since a user can peruse the contents assigned to a TV channel as a program table, the user can easily grasp the whereabouts and information of a TV program and the content data acquired via the network. Therefore, the user can easily chose the content data.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A content-recording apparatus comprising:
a network connection unit operable to acquire content data via a network;
a TV program-acquiring unit operable to acquire content data from a broadcasting station;
a content-recording unit operable to record the content data acquired via the network and the content data acquired from the broadcasting station;
an entering unit operable to receive command information entered by a user;
a display control unit operable to generate a signal-for-display-device based on the content data recorded by said content-recording unit; and
a control unit operable to search at said content-recording unit content data related to the command information received by said entering unit to make, when the content data related to the command information received by said entering unit exists, said display control unit generate a signal-for-display-device based on the content data related to the command information received by said entering unit,
wherein, when the content data acquired by said network connection unit via the network has been recorded by said content-recording unit and is able to be reproduced, said display control unit generates a signal-for-display-device notifying the user that the content data acquired by said network connection unit via the network has been recorded by said content-recording unit and is able to be reproduced.

2. The content-recording apparatus of claim 1, wherein, when the content data acquired by said network connection unit via the network has been recorded by said content-recording unit and is able to be reproduced, said display control unit generates a signal-for-display-device displaying a sub screen notifying the user that the content data acquired by said network connection unit via the network is able to be reproduced.

3. The content-recording apparatus of claim 2, wherein said display control unit closes the sub screen when the content data is reproduced.

4. The content-recording apparatus of claim 2, wherein said display control unit changes the sub screen after an amount of time.

5. The content-recording apparatus of claim 1, wherein when, while displaying nothing, the content data acquired by said network connection unit via the network has been recorded by said content-recording unit and is able to be reproduced and displaying based on a signal-for-display-device has begun, said display control unit generates a signal-for-display-device displaying a sub screen notifying the user that the content data acquired by said network connection unit via the network is able to be reproduced.

6. The content-recording apparatus of claim 2, wherein the sub screen comprises character information.

7. The content-recording apparatus of claim 2, wherein said display control unit is operable to reproduce a sound accompanying the sub screen.

8. The content-recording apparatus of claim 2, wherein the sub screen comprises one or more items selected from a group of a title, a message, transmission source information, transmission time, receiving time, reproduction time length, and data size.

9. The content-recording apparatus of claim 2, wherein the sub screen comprises a channel number assigned to the content data recorded by said content-recording unit.

10. The content-recording apparatus of claim 1, wherein, when the content data acquired by said network connection unit via the network has been recorded by said content-recording unit and is able to be reproduced, said display control unit generates a signal-for-display-device reproducing a sound notifying the user that the content data acquired by said network connection unit via the network is able to be reproduced.

11. The content-recording apparatus of claim 2, wherein the sub screen comprises one or more items selected from a group of a still image and the content data acquired by said network connection unit via the network.

12. The content-recording apparatus of claim 1, wherein, when the content data acquired by said network connection unit via the network has been recorded by said content-recording unit and is able to be reproduced, said display control unit generates a signal-for-display-device performing an unusual display.

13. A content-recording apparatus comprising:
a network connection unit operable to acquire content data via a network;
a TV program-acquiring unit operable to acquire content data from a broadcasting station;
a content-recording unit operable to record the content data acquired via the network and the content data acquired from the broadcasting station; and
a display control unit operable to generate, according to EPG information that at least one of said network connection unit and said TV program-acquiring unit has acquired from the broadcasting station, a signal-for-display-device displaying a content list,
wherein said display control unit manages the content data acquired by said TV program-acquiring unit and the content data acquired by said network connection unit in the content list equivalently.

14. The content-recording apparatus of claim 13, wherein said content-recording unit records the content data acquired by said network connection unit relating to a channel assigned to at least one of a transmitter and a transmitter's group having transmitted the content data acquired by said network connection unit;
wherein said content-recording unit records the content data acquired by said TV program-acquiring unit relating to a channel assigned to the broadcasting station; and
wherein the content list comprises a channel assigned to the at least one of the transmitter and the transmitter's group having transmitted the content data acquired by said network connection unit.

15. The content-recording apparatus of claim 13, wherein the content list further comprises:
a vertical axis; and
a horizontal axis,
wherein either the vertical axis or the horizontal axis is a channel number axis having a channel that at least one of a transmitter and a transmitter's group having transmitted the content data acquired by said network connection unit can be assigned to.

16. The content-recording apparatus of claim 13, wherein the content list further comprises:
a vertical axis; and
a horizontal axis,
wherein one of the vertical axis and the horizontal axis is a channel number axis, and
wherein another of the vertical axis and the horizontal axis shows an order of reproduction of the content data recorded by said content-recording unit.

17. The content-recording apparatus of claim 13, wherein the content list further comprises:
a vertical axis; and
a horizontal axis,
wherein one of the vertical axis and the horizontal axis is a channel number axis, and
wherein another of the vertical axis and the horizontal axis shows reproduction time of the content data recorded by said content-recording unit.

18. A content-reproducing apparatus comprising:
a network connection unit operable to acquire content data via a network;
a TV program-acquiring unit operable to acquire content data from a broadcasting station;
a content-recording unit operable to record the content data acquired via the network and the content data acquired from the broadcasting station;
an entering unit operable to receive command information entered by a user;
a display control unit operable to generate a signal-for-display-device based on the content data recorded by said content-recording unit;
a control unit operable to search at said content-recording unit content data related to the command information received by said entering unit to make, when the content data related to the command information received by said entering unit exists, said display control unit generate a signal-for-display-device based on the content data related to the command information received by said entering unit; and
a monitor operable to display according to the signal-for-display-device generated by said display control unit,
wherein, when the content data acquired by said network connection unit via the network has been recorded by said content-recording unit and is able to be reproduced, said display control unit generates a signal-for-display-device notifying the user that the content data acquired by said network connection unit via the network has been recorded onto said content-recording unit and is able to be reproduced.

19. A content-recording method comprising:
acquiring content data via a network;
recording the content data acquired via the network onto a content-recording unit;
generating a signal-for-display-device based on the content data recorded onto the content-recording unit;
receiving command information entered by a user;
acquiring content data from a broadcasting station;
searching at the content-recording unit content data related to the command information entered by the user to generate, when the content data related to the command information entered by the user exists, a signal-for-display-device based on the content data related to the command information entered by the user; and
generating, when the content data acquired via the network has been recorded onto the content-recording unit and is able to be reproduced, a signal-for-display-device notifying the user that the content data acquired via the network has been recorded onto the content-recording unit and is able to be reproduced.

20. The content-recording method of claim 19, wherein said generating of the signal-for-display-device notifying the user comprises,
generating, when the content data acquired via the network has been recorded onto the content-recording unit and is able to be reproduced, a signal-for-display-device displaying a sub screen notifying the user that the content data acquired via the network is able to be reproduced.

21. The content-recording method of claim 20, wherein the sub screen is closed when the content data is reproduced.

22. The content-recording method of claim 20, wherein the sub screen is changed after an amount of time.

23. The content-recording method of claim 19, wherein when, while displaying nothing, the content data acquired via the network has been recorded onto the content-recording unit and is able to be reproduced and displaying based on a signal-for-display-device has begun, said generating of the signal-for-display-device notifying the user comprising generating a signal-for-display-device displaying a sub screen notifying the user that the content data acquired by the network connection unit via the network is able to be reproduced occurs.

24. The content-recording method of claim 20, wherein the sub screen comprises character information.

25. The content-recording method of claim 20, further comprising reproducing a sound while displaying the sub screen.

26. The content-recording method of claim 20, wherein the sub screen comprises one or more items selected from a group of a title, a message, transmission source information, transmission time, receiving time, reproduction time length, and data size.

27. The content-recording method of claim 20, wherein the sub screen comprises a channel number assigned to the content data recorded onto the content-recording unit.

28. The content-recording method of claim 19, wherein, when the content data acquired via the network has been recorded onto the content-recording unit and is able to be reproduced, said generating of the signal-for-display-device notifying the user comprising generating a signal-for-display-device reproducing a sound notifying the user that the content data acquired by the network connection unit via the network is able to be reproduced occurs.

29. The content-recording method of claim 20, wherein the sub screen comprises one or more items selected from a group of a still image and the content data acquired via the network.

30. The content-recording method of claim 19, wherein, when the content data acquired via the network has been recorded onto the content-recording unit and is able to be reproduced, said generating of the signal-for-display-device notifying the user comprising generating a signal-for-display-device performing an unusual display occurs.

31. A content-recording method comprising:
acquiring content data via a network;
acquiring content data from a broadcasting station;
recording the content data acquired via the network and the content data acquired from the broadcasting station onto a content-recording unit; and
generating, according to EPG information acquired from the broadcasting station, a signal-for-display-device displaying a content list,
wherein the content data acquired from the broadcasting station and the content data acquired via the network are managed in the content list equivalently.

32. The content-recording apparatus of claim 31, wherein the content-recording unit records the content data acquired via the network relating to a channel assigned to at least one of a transmitter and a transmitter's group having transmitted the content data acquired via the network;
wherein the content-recording unit records the content data acquired from the broadcasting station relating to a channel assigned to the broadcasting station; and
wherein the content list comprises a channel assigned to the at least one of the transmitter and the transmitter's group having transmitted the content data acquired via the network.

33. The content-recording apparatus of claim 31, wherein the content list further comprises:
a vertical axis; and
a horizontal axis,
wherein either the vertical axis or the horizontal axis is a channel number axis having a channel that at least one of a transmitter and a transmitter's group having transmitted the content data acquired via the network can be assigned to.

34. The content-recording apparatus of claim 33, wherein the content list further comprises:
a vertical axis; and
a horizontal axis,
wherein one of the vertical axis and the horizontal axis is a channel number axis, and
wherein another of the vertical axis and the horizontal axis shows an order of reproduction of the content data recorded onto the content-recording unit.

35. The content-recording apparatus of claim 33, wherein the content list further comprises:
a vertical axis; and
a horizontal axis,
wherein one of the vertical axis and the horizontal axis is a channel number axis, and
wherein another of the vertical axis and the horizontal axis shows a reproduction time of the content data recorded onto the content-recording unit.

36. A recording medium having a content-recording program recorded therein, said content-recording program comprising:
a program portion operable to acquire content data via a network;
a program portion operable to record the content data acquired via the network onto a content-recording unit;
a program portion operable to generate a signal-for-display-device based on the content data recorded onto the content-recording unit;
a program portion operable to receive command information entered by a user;
a program portion operable to acquire content data from a broadcasting station;
a program portion operable to search at the content-recording unit content data related to the command information entered by the user to generate, when the content data related to the command information entered by the user exists, a signal-for-display-device based on the content data related to the command information entered by the user; and
a program portion operable to generate, when the content data acquired via the network has been recorded onto the content-recording unit and is able to be reproduced, a signal-for-display-device notifying the user that the content data acquired via the network has been recorded onto the content-recording unit and is able to be reproduced.
